(19) United States
(12) Patent Application Publication
(10) Pub. No.: US 2011/0074075 A1
(43) Pub. Date: Mar. 31, 2011

(54) APPARATUS, SYSTEM, AND METHOD FOR A CUSHIONING ELEMENT

(76) Inventors: George Travie Henry, JR., Toccoa, GA (US); Diane Marie Henry, Toccoa, GA (US)

(21) Appl. No.: 12/892,905

(22) Filed: Sep. 28, 2010

Related U.S. Application Data
(60) Provisional application No. 61/246,306, filed on Sep. 28, 2009.

(51) Int. Cl. F16F 1/36; F16F 7/00

(52) U.S. Cl. 267/141; 267/153

(57) ABSTRACT

A cushioning element includes a two-sided membrane. The membrane may be of any size and shape appropriate to a desired application. Units extend from each side of the membrane with units on one side staggered or offset from those of the other. Depressing a unit on one side of the membrane causes displacement of at least part of the other side of the membrane into the space opposite to the depressed unit. Releasing the depressed unit allows the membrane to return to at least substantially its previous position. Membrane resiliency may be consistent throughout an embodiment or part(s) may be differently resilient. Units may be consistent in resiliency, size and/or shape on one or both sides of an embodiment, or may vary on one or both sides. Membrane and units may be integrally made in whole or in part within an embodiment. The cushioning element may have vibration dampening characteristics.

### CROSS-REFERENCE TO RELATED APPLICATION

The present application claims priority to and benefit of the prior filed co-pending and commonly owned provisional application, filed in the United States Patent and Trademark Office on Sep. 28, 2009, assigned Ser. No. 61/246,306, entitled Apparatus, System, and Method for a Cushioning Element, and incorporated herein by reference.

### FIELD OF THE INVENTION

The invention relates to apparatuses, systems, and methods that may comprise or make use of devices that may be used as cushioning elements, vibration dampeners or absorbers, spacers, and/or combinations thereof, and/or devices with similar characteristics.

### BACKGROUND

Various cushions, body supports, pads, and the like have been previously described in patents, patent application publications and other documents such as: Apperson, et al., United States Patent Application Publication Nos. US 2006/0260059 and US 2006/0260060; Graebe, U.S. Pat. Nos. 4,541,136, 5,152,023 and 7,424,761; Kuo, U.S. Pat. No. 6,842,926; McCann et al., United States Patent Application Publication No. US 2005/0223667; Mossbeck, United States Patent Application Publication No. US 2008/0060139; Pearce, U.S. Pat. Nos. and 6,026,527 and 6,865,759; Sias et al., U.S. Pat. Nos. 4,605,582 and 4,673,605 and Skiba et al., United States Patent Application Publication No. 2007/0088392. All of these cited documents are incorporated herein by reference.

### SUMMARY

Generally stated, the invention relates to cushions, vibration absorbers, and the like. Advantageously, the embodiments of the inventions may be used in a variety of ways and in many different circumstances. The exemplary embodiments of the invention are described herein as being used with specific elements and features, but should not be limited to the particular examples given. One or more of the inventions may be used in other circumstances and/or with other elements or features.

For example, the invention may be implemented as a cushioning element that includes a two-sided membrane. The membrane may be of any size and shape appropriate to a desired application. Protrusions may extend from each side of the membrane with protrusions on one side staggered or offset with respect to the protrusions those of the other side. Depressing a protrusion on one side of the membrane may cause displacement of at least part of the other side of the membrane into the space opposite to the depressed protrusion. Releasing the depressed unit may allow the membrane to return to at least substantially its previous position.

In some embodiments, initial depression of a protrusion may cause the protrusion to compress and releasing the initial depression may cause at least its substantial decompression. In some embodiments, additional depression of a protrusion (additional to the depression mentioned in the previous paragraph rather than the immediately preceding sentence) may move at least part of the protrusion into a space on the other side of the membrane. Releasing the additional depression on the unit may cause the moved part of it to return substantially at least to its position prior to the additional depression.

Membrane resiliency may be consistent throughout an embodiment or part(s) may be differently resilient. Protrusions may be consistent in resiliency, size and/or shape on one or both sides of an embodiment, or may vary on one or both sides. Membrane and protrusions may be integrally made in whole or in part within an embodiment. One or more protrusions may be attached to a membrane differently from other protrusions on one or both sides of a membrane. In some embodiments, one or more protrusions may not be attached to the membrane but may be “external” to the membrane in that they may operate on or support the membrane without being attached to it.

An embodiment of the invention may have protrusions configured in a pattern on one or both sides of the membrane. For example, a grid pattern of rows and columns of protrusions may be used. If patterns are used, they may follow the stagger or offset positioning of the projections on opposite sides of the membrane. The cushioning element may have vibration dampening characteristics.

The invention also may be embodied, for example, as an apparatus positionable between a vibration source and a pressure source. This apparatus may include pressure source-side members with each member oriented towards the pressure source. The apparatus also may include vibration-side elements with each element oriented towards the vibration source. In this embodiment, at least two of the elements are positioned so as to define an area between them. Further in this apparatus, at least one of the members is positioned generally opposite to the area between the two elements. The member so positioned is at least partially compressible in response to pressure from the pressure source. In addition in this apparatus, the vibration-side elements may be at least partially absorptive of vibration from the vibration source.

The invention may be further implemented as a device usable for cushioning or shock absorption, or both. This device may include upward projections and downward projections. The downward projections may be staggered in positional relation to the upward projections. In this device, at least one of the upward projections is compressible in response to pressure and also being resilient in response to removal of the pressure. Further, in this device at least part of a downward projection is capable of being distorted into a position between at least two of the upward projections. At least part of an upward projection is capable of being distorted into a position between at least two of the downward projections.

The invention may be incorporated in many different embodiments so the invention may be applied to many fields. As examples, the invention may be incorporated in embodiments which are delicate and light or which are robust and heavy. An embodiment may be made to be high load bearing and may have high compression characteristics. The response curve of a particular embodiment may be engineered to the needed application. Load bearing characteristics may be varied by the choice and application of durometer elastomeric materials, elastomeric membrane diaphragm thickness, protrusion design, combination of resultant forces, and cushioning or spring stroke.

Potential applications of the invention are many. For example, embodiments of the invention may be configured as general seating pads or seating. These may include child restraint seat pads, driver cushions, household furniture seating, hunting stand pads, infant pads, mattress pads, mattresses, office furniture seats, pillows, stadium pads, and/or toilet seats. Other examples of embodiments may relate to contractor/construction/agricultural uses such as agricultural seats and seat pads, contractor tool handle anti-vibration pads, chain saw handle anti-vibration pads, conveyor shaker springs, cushioned non-pneumatic flat-proof equipment tires (fork lifts, front end loaders, etc.), expansion joints, heavy equipment seats and seat pads, knee-elbow pads, lawn care equipment grips, pads for powered polishing, vibration resistant gloves, and weather stripping.

Embodiments of the invention also may be used in the fields of sports, recreation and exercise. These may include artificial turf padding, athletic field padding, ballet toe pad, rider in-the-shorts cushioning, bicycle shorts padding, bicycle seat, camping pad, canoe/kayak/boat seats, computer game controller grip, canoe/kayak boat pads, dance floors, exercise equipment, football/sport protective pads, firearm shoulder pad, gymnastic mats, grips for golf clubs, tennis racquets, etc, high impact seating (boat racing, off road racing etc.), horse trailer mat, indoor running track padding, impact protection (head gear, etc.) load distribution shoulder strap (back packs, etc.), martial arts uses, playground protection, pistol grip, stadium seats, saddles (rider protection), saddles (horse protection), swimming pool bumper pads, tread mill uses, and toys.

In addition, embodiments of the invention may be used in the medical field. For example, embodiments may be used in or in connection with antidecubitis pad or mattress, backboard pad, examination table pad, gurney pad, neck support pad for lower back support belt, cushioning for prosthetics, and wheel chair seat and pad.

Further, there may be aircraft related uses of exemplary embodiments of the invention such as in aircraft seats and seat pads, and in helicopter pads. Automotive uses of exemplary embodiments may include automotive seats and seat pads, carpet padding and sound deadening, driver protection, run-flat tires, suspensions-automotive, and truck seats and pads. Exemplary embodiments may have household uses such as in appliance cushions and carpet pads.

Motor sports may be another field of use for exemplary embodiments of the invention. Such uses may include helmet liners, internal handlebar vibration dampeners, motorcycle seats and seat pads, motorcycle foot pegs, grips, floorboards, jackets, riding gear, and riding suit protective armor. Further, snowmobile seats and suspensions may be other fields of use.

There may be many other uses of exemplary embodiments of the invention. Miscellaneous other uses may include (but not be limited to) adhesive backed strips, anti-vibration uses, vibration control and vibration absorption uses, electronic suspensions, energy absorbing pads, highway barriers, keyboard wrist rests, packaging that provides anti-vibration properties, pulse dampeners, speedway barriers, shoe insoles, sound deadening, and shoe materials such as outer soles.

Exemplary embodiments according to the invention have been summarized above. Many more are possible; the inventions are not to be limited to these examples. Other features and advantages of the inventions may be more clearly understood and appreciated from a review of the following detailed description and by reference to the appended drawings and claims.

### BRIEF DESCRIPTION OF THE DRAWINGS

FIGS. 1A and 1B are side views of a simplified version of an exemplary embodiment according to the invention.

FIGS. 2A and 2B are side views of a simplified version of an exemplary embodiment according to the invention.

FIGS. 3A and 3B are side views of a simplified version of an exemplary embodiment according to the invention.

FIGS. 4A and 4B are side views of a simplified version of an exemplary embodiment according to the invention.

FIGS. 5A and 5B are side views of a simplified version of an exemplary embodiment according to the invention.

FIGS. 6A and 6B are side views of a simplified version of an exemplary embodiment according to the invention.

FIGS. 7A, 7B and 7C are side views of a simplified version of an exemplary embodiment according to the invention.

FIGS. 8A, 8B and 8C are side views of a simplified version of an exemplary embodiment according to the invention.

FIGS. 9A and 9B are side views of a simplified version of an exemplary embodiment according to the invention.

FIGS. 10A and 10B are side views of a simplified version of an exemplary embodiment according to the invention.

FIGS. 11A and 11B are side views of a simplified version of an exemplary embodiment according to the invention.

FIGS. 12A and 12B are side views of a simplified version of an exemplary embodiment according to the invention.

FIGS. 13A and 13B are side views of a simplified version of an exemplary embodiment according to the invention.

FIG. 14 is a side view of a simplified version of an exemplary embodiment according to the invention.

FIG. 15 is a top view of an exemplary embodiment according to the invention.

FIG. 16A is a top view of an exemplary embodiment according to the invention.

FIG. 16B is a cutaway side view of the exemplary embodiment of FIG. 16A taken along the diagonal A-A in FIG. 16A.

FIG. 16C is a cutaway side view of the exemplary embodiment of FIG. 16A taken along the line BB in FIG. 16A.

FIG. 16D is a side view of the exemplary embodiment of FIG. 16A with a load applied.

FIG. 17 is a cutaway side perspective view of part of the exemplary embodiment of FIG. 16A as it may be used in an assembly on a motorcycle seat.

### DETAILED DESCRIPTION

The inventions are described herein with reference to exemplary embodiments, alternative embodiments, and also with reference to the attached drawings. The invention, however, can be embodied into many different forms and carried out in a variety of ways, and should not be construed as limited to the embodiments set forth in this description and/or the drawings. The exemplary embodiments that are described and shown herein are only some of the ways to implement the inventions. Elements and/or actions of the inventions may be assembled, connected, configured, and/or taken in an order different in whole or in part from the descriptions herein.

The invention as embodied in different ways may be referred to variously as a cushion, cushioning element, spring, pad, gel pad, or a vibration or shock absorber, or combinations of those terms. The nomenclature may vary depending on the use to which the particular embodiment of the invention is put.

Generally, the invention is embodied as a two-sided device. The two-sided nature of the device may lead to the temptation to refer to the particular sides by terms that assign specific positions or placement. For example, one side might be referred to as the “top”, “upper”, or the “right side” and the other side might be referred to as the “bottom”, “lower”, or the “left side”. But the sides of the exemplary embodiments should not be limited to such positions or placement unless it is appropriate to a particular embodiment. An advantage of some of the embodiments of the invention is that they may be “flipped” or turned over so that what was the top is then the bottom and vice versa. Similarly, an embodiment may be re-oriented during use or otherwise so that what was the right side becomes the left side (and vice versa). Thus, use of position terms such as “top” or “bottom” may be necessary herein because of the limitations of two-dimensional illustrations but the elements should not be so limited.

Generally stated, the invention may be embodied as a cushioning element having two sides with protrusions on either side. “Protrusions” also may be referred to as “units”, “projections”, “members” or “elements” herein. Use of the term “protrusion” herein does not mean the so-called element is necessarily always made from another element so as to be an extension of that other element. Rather, the term “protrusion” is used generally herein to refer to an element that projects or sticks. As will be noted herein, however, in some embodiments, a protrusion may be made integral with another element rather than be a separate piece.

As noted, the invention may be embodied as a cushioning element having two sides with protrusions. Embodiments of the invention may have projections on one side of the cushioning element that preferably are stagger positioned with respect to the projections on the other side. Stagger positioning also may be referred to as “offset” positioning or placement. An advantage of the staggered positioning is that depression of a projection on one side of the cushioning element may cause displacement or distension of at least part of the other side of the cushioning element. The displacement may come about as a result of resilient materials used in the cushioning element. Removing the pressure from the projection allows the displaced part of the cushioning element to return to its former position.

In some embodiments, the cushioning element may include a membrane that is generally centrally positioned with the projections of the cushioning element on either side of the membrane. The membrane may be substantially flat in some embodiments or not in other embodiments as appropriate to the use to which the particular embodiment of the cushioning element is to be put. The membrane may be relatively thick or thin—again as appropriate to the desired use of the particular embodiment. Additional information about the use of relatively thick or thin membranes is provided below in connection with some of the figures included herein. The membrane may be of any appropriate size and/or peripheral shape depending on the intended use of a particular embodiment.

The membrane of an exemplary cushioning element may be provided in some embodiments as a distinct unit, whether made integrally with the projections or separately. In some other embodiments, a membrane may be considered less than a completely separate element such as a membrane that may be brought about by the overlap of the materials creating the protrusions of the cushioning element. Where a membrane is used, the depression of a projection on one side of the membrane may cause the displacement of the part of the membrane on the opposite side of the projection. Release of the projection may allow the membrane to return to its unloaded position.

More particularly stated, an exemplary embodiment of the invention may use an elastomeric membrane diaphragm, which may also be referred to as a membrane, a diaphragm, a membrane diaphragm, or similarly. The membrane may be made of a resilient material to allow for the distension and return to original position. For example, an elastomeric gel may be used.

Continuing with the more particular explanation of an exemplary embodiment, a load may be applied to the membrane of the embodiment through a single or plurality of protrusions, which may be of any geometric shape or configuration as may fit the purpose. Certain protrusions or other means may transmit the applied force to the membrane. Certain protrusions or other means may support the membrane to resist the applied load. Each contact point of the protrusion or other means with the membrane may generate a distension of the membrane as a load is applied, with resultant generated forces. These resultant forces in combination may be considered the spring or cushioning supporting the load.

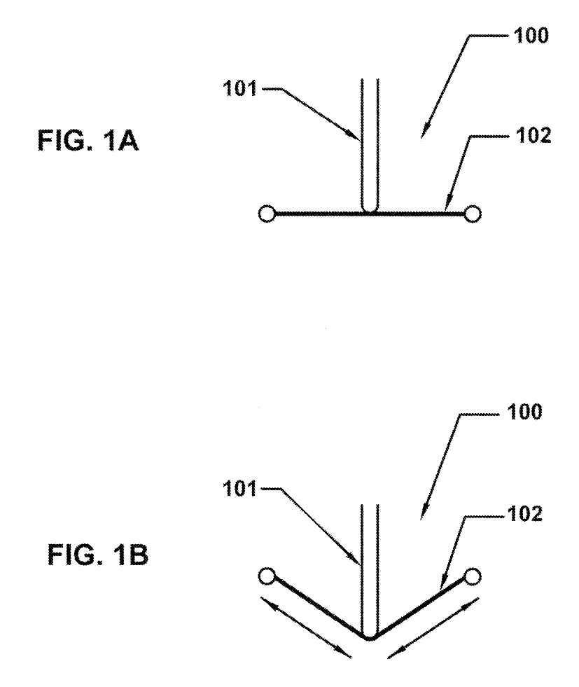

Particularly, an exemplary device may be peripherally or otherwise supported and restrained. As a load is applied, because of the elasticity of the membrane, it will distend and attempt to return to the original no-load state. This is the cushioning or spring action. FIGS. 1A, B-14A, B provide additional details regarding the spring action as may be used in various embodiments according to the invention. These figures present a simplified side view of possible embodiments.

FIGS. 1A-1B illustrate an example (simplified for explanation) of a device 100 having a relatively thin membrane 102 with a single upper protrusion 101. It is unlikely (but possible) an exemplary embodiment would have only a single protrusion but the example is provided herein for ease of explanation. FIG. 1A illustrates the exemplary device 100 without application of an external force. In FIG. 1B, an external force is applied in a downward manner to the protrusion 101, which downwardly distends the membrane 102. When the force is removed, the membrane 103 with protrusion 101 returns or “springs” back to its original position as shown in FIG. 1A. The spring action is primarily caused by the tension generated in the membrane 102 as a result of distension caused by the external force.

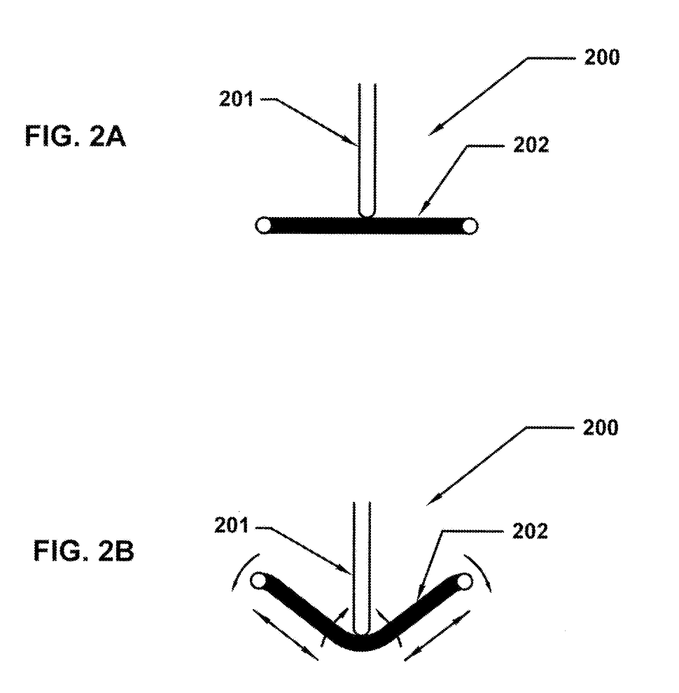

FIGS. 2A-2B illustrate a simplified example of an exemplary device 200 and its action when an external force is downwardly applied to the protrusion 201, but with a thicker membrane 202 than in the example illustrated in FIGS. 1A-1B. For relatively thick membranes, the resulting spring action is caused by combining the tension generated in the membrane as a result of distension caused by an external force and resistance to the bending moment which results from the deflection of the thicker elastomeric membrane. Since the material of the membrane is elastic, the resistance to bending moment combines with the tensioning force, increasing the resultant spring or cushioning force applied to the protrusion 201.

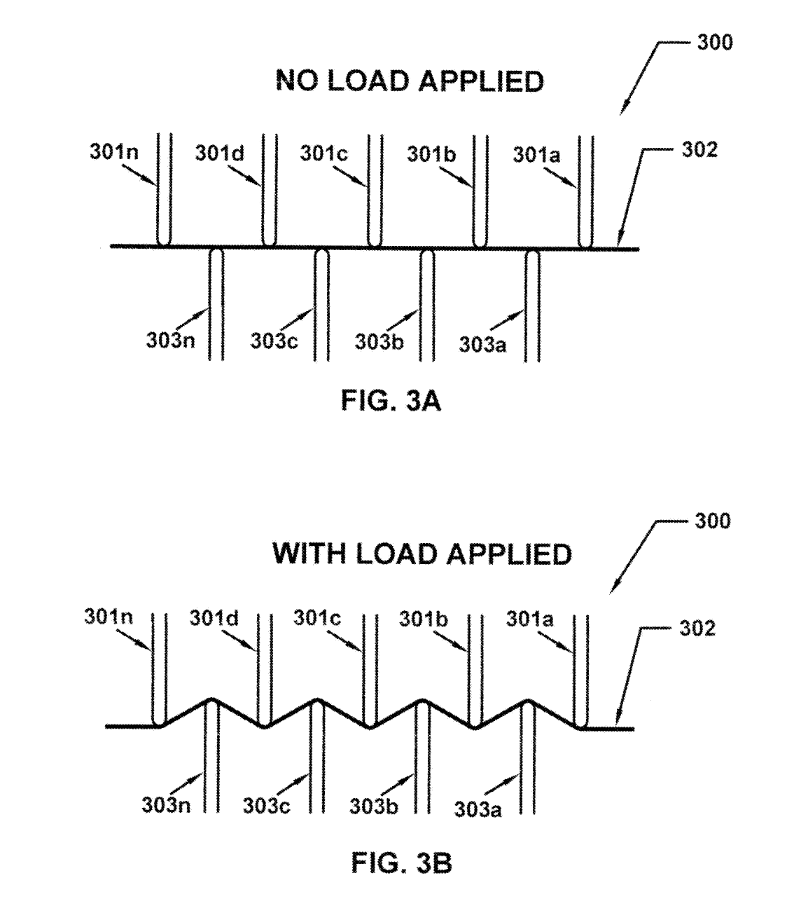

FIGS. 3A-3B illustrate a simplified embodiment of an exemplary device 300 of the present invention which utilizes a plurality of protrusions 301a-n, 303a-n external to the thin elastomeric membrane diaphragm 302 and acting on or with respect to the diaphragm 302. A load (not shown) applied to the plurality of protrusions 301a-n acting on a single thin elastomeric membrane diaphragm 302 causes the diaphragm 302 to distend at each load resisting contact point. This results in a multiplied resultant spring or cushioning force. FIG. 3A illustrates the embodiment 300 with no load applied. FIG. 3B illustrates the embodiment 300 with the load applied. Protrusions 301a-n transmit the load to the thin elastomeric membrane diaphragm 302c. FIG. 3A illustrates the thin elastomeric membrane diaphragm 302 with no load applied. Protrusions 303a-n support the thin elastomeric membrane diaphragm 302. FIG. 3B illustrates the thin elastomeric membrane diaphragm 302 with load applied.

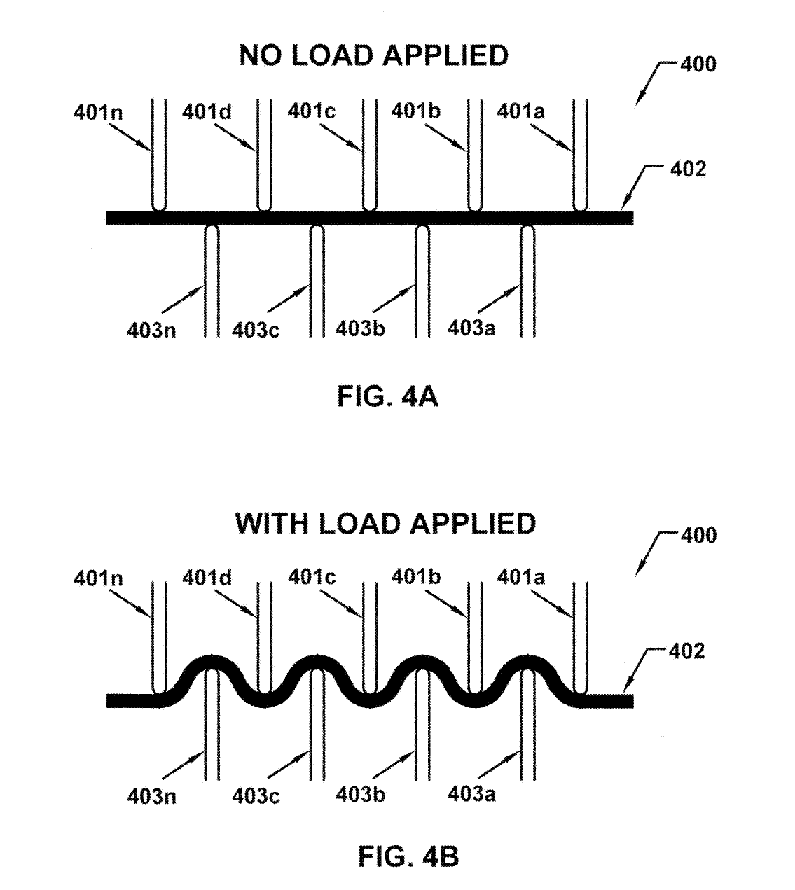

FIGS. 4A-4B illustrate a simple exemplary embodiment 400 of the present invention which utilizes a plurality of protrusions 401a-n, 403a-n external to a thick elastomeric membrane diaphragm 402 and acting on or with respect to the diaphragm 402. A load (not shown) applied to a plurality of protrusions 401a-n acting on a single thick elastomeric membrane diaphragm 402 causes the diaphragm 402 to distend and deflect at each load resisting contact point. This results in a multiplied resultant spring or cushioning force. FIG. 4A illustrates the embodiment 400 with no load applied. FIG. 4B illustrates the embodiment 400 with the load applied. Protrusions 401a-n transmit the load to the thick elastomeric membrane diaphragm 402. FIG. 4A illustrates the thick elastomeric membrane diaphragm 402 with no load applied. Protrusions 403a-n support the thick elastomeric membrane diaphragm 402. FIG. 4B illustrates the thick elastomeric membrane diaphragm 402 with load applied.

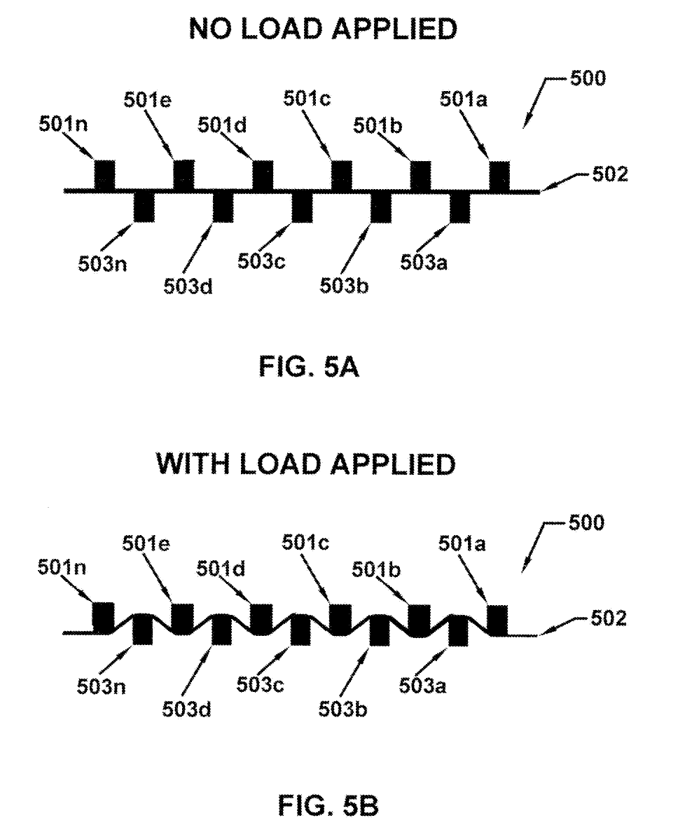

FIGS. 5A-5B illustrate an exemplary embodiment 500 of the present invention which utilizes a thin elastomeric membrane diaphragm 502 with the protrusions 501a-n, 503a-n as an integral part of the membrane. A load (not shown) applied to the plurality of protrusions 501a-n acting on a single elastomeric membrane diaphragm 502 causes the diaphragm 502 to distend and deflect at each load resting protrusion 503a-n. FIG. 5A illustrates the thin elastomeric membrane diaphragm 502 with the integral protrusions 501a-n, 503a-n with no load applied. FIG. 5B illustrates the thin elastomeric membrane 502 with the integral protrusions 501a-n, 503a-n with a load applied.

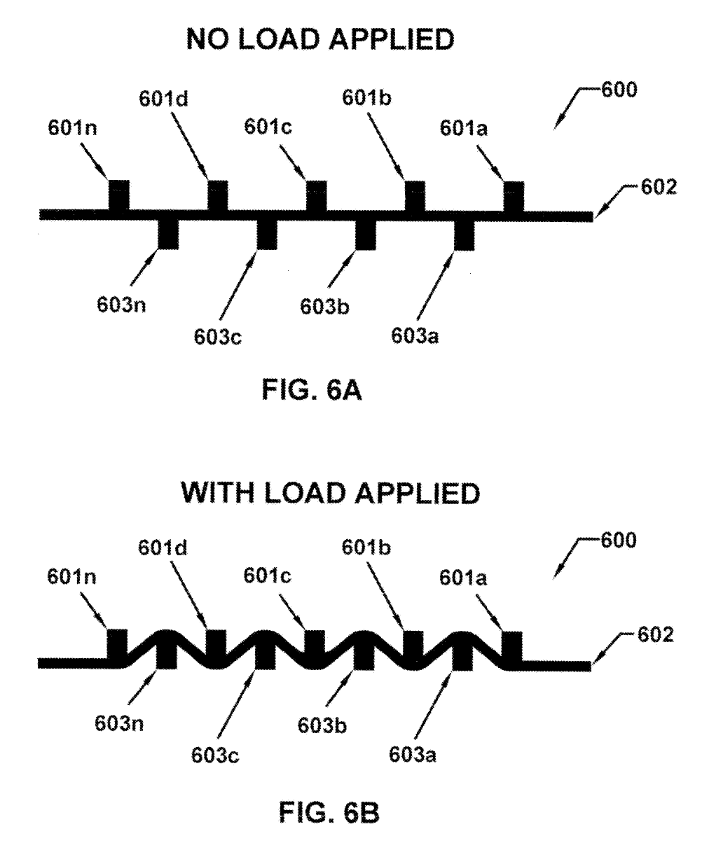

FIGS. 6A-6B illustrate an exemplary embodiment 600 of the present invention which utilizes a thick elastomeric membrane diaphragm 602 with the protrusions 601a-n, 603a-n as an integral part of the membrane 602. A load (not shown) applied to a plurality of protrusions 601a-n acting on a single elastomeric membrane diaphragm 602 causes the diaphragm 602 to distend and deflect at each load resisting protrusion 603a-n. FIG. 6A illustrates the thick elastomeric membrane diaphragm 602 with the integral protrusions 601a-n, 603a-n without a load applied. FIG. 6B illustrates the thick membrane 602 with the integral protrusions 601a-n, 603a-n with a load applied.

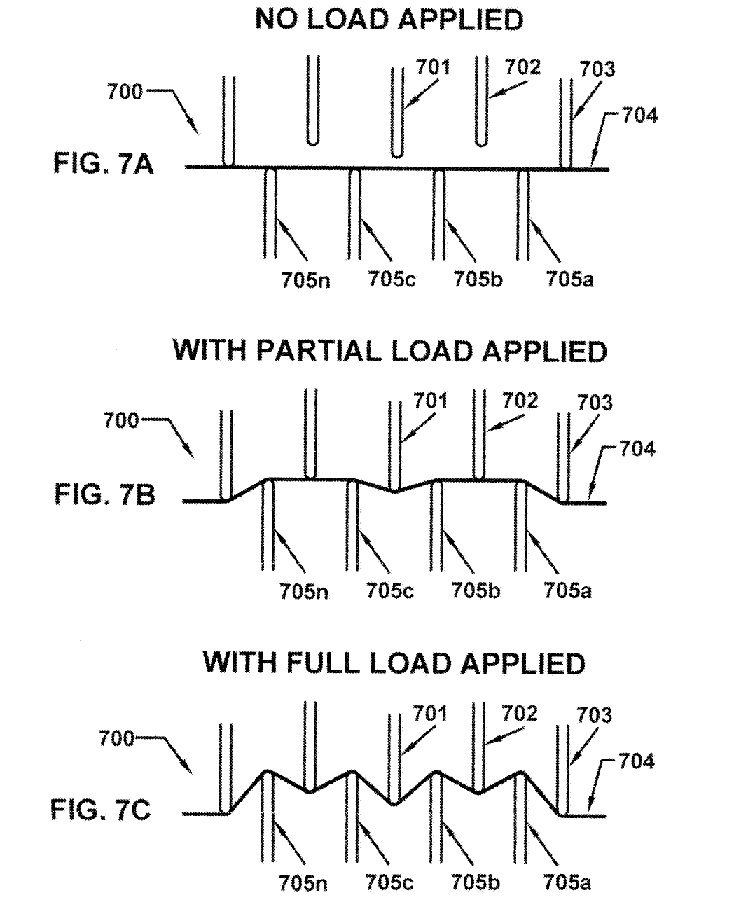

FIGS. 7A-C illustrate a simple exemplary embodiment 700 of the present invention which utilizes a plurality of protrusions 701, 702, 703 of varying length external to the elastomeric membrane diaphragm 704 and acting on the diaphragm 704. A load (not shown) applied to a plurality of protrusions 701, 702, 703 acting on a single elastomeric membrane diaphragm 704 causes the diaphragm 704 to distend and deflect at each load resisting protrusion 705a-n. A plurality of protrusions of varying lengths 701, 702, 703 make contact with the elastomeric membrane diaphragm 704 with differing timing. Each length of protrusion generates a different level of distension in the elastomeric membrane diaphragm 704. As each length makes contact in succession with the elastomeric membrane diaphragm 704, the spring or cushioning action is increased. The timing of this increase is determined by the application rate of the load and the length of the protrusions. Total spring rate or cushioning may be engineered to meet a specific requirement. FIG. 7A illustrates the embodiment 700 with no load applied. FIG. 7B illustrates the embodiment 704 with a partial load (not shown) applied. FIG. 7C illustrates the embodiment 700 with a full load (not shown) applied. Long length external protrusion 703 is used to transmit the load to the elastomeric membrane diaphragm 704. Medium length external protrusion 701 is used to transmit the load to the elastomeric membrane diaphragm 704. Short length external protrusion 702 is used to transmit the load to the elastomeric membrane diaphragm 704. FIG. 7A illustrates the elastomeric membrane diaphragm 704 with no load applied. In FIGS. 7A-7C, the protrusions 705a-n support the elastomeric membrane diaphragm 704.

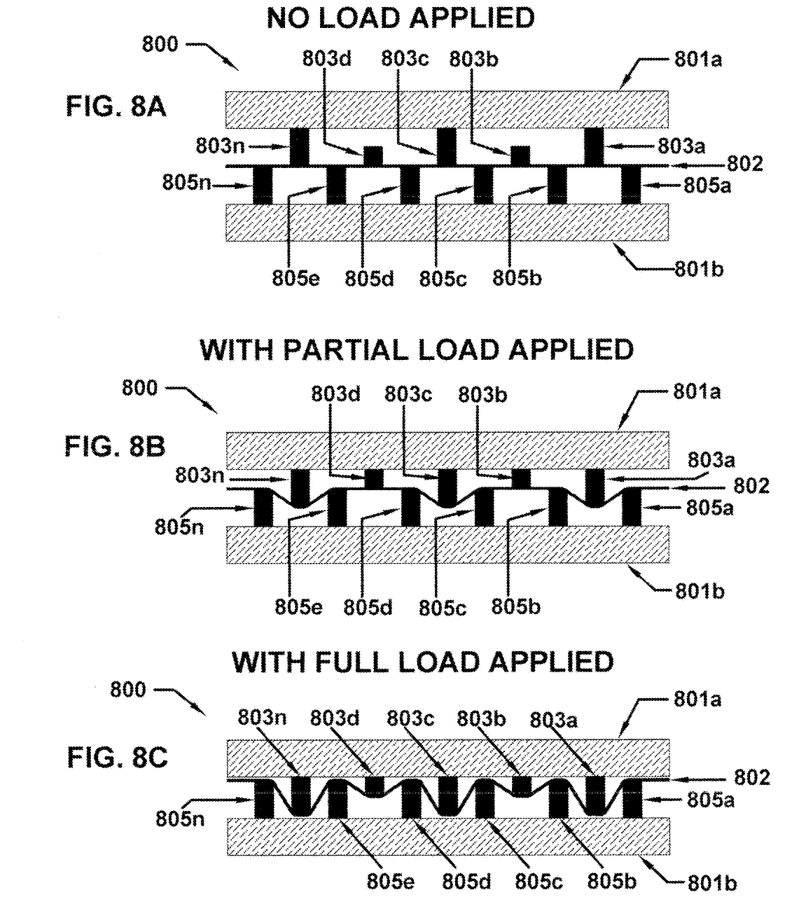

FIGS. 8A-C illustrate an exemplary embodiment 800 of the present invention which utilizes an elastomeric membrane diaphragm 802 with integral protrusions 803a-n, 805a-n. The protrusions 803a-n transmitting the load are of various lengths. A load applied to a plurality of protrusions 803a-n acting on a single elastomeric membrane diaphragm 802 causes the diaphragm 802 to distend and deflect at each load resisting protrusion 805a-n. The various lengths of the protrusions 803a-n allow for an increasing rate of resistance as the load is applied. FIGS. 8A-8C include a load transmitting 801a, b material on either side (top and bottom as illustrated) of the embodiment 800. FIG. 8A illustrates the embodiment 800 with no load applied. FIG. 8B illustrates the embodiment 800 with a partial load applied. FIG. 8C illustrates the embodiment 800 with a full load applied.

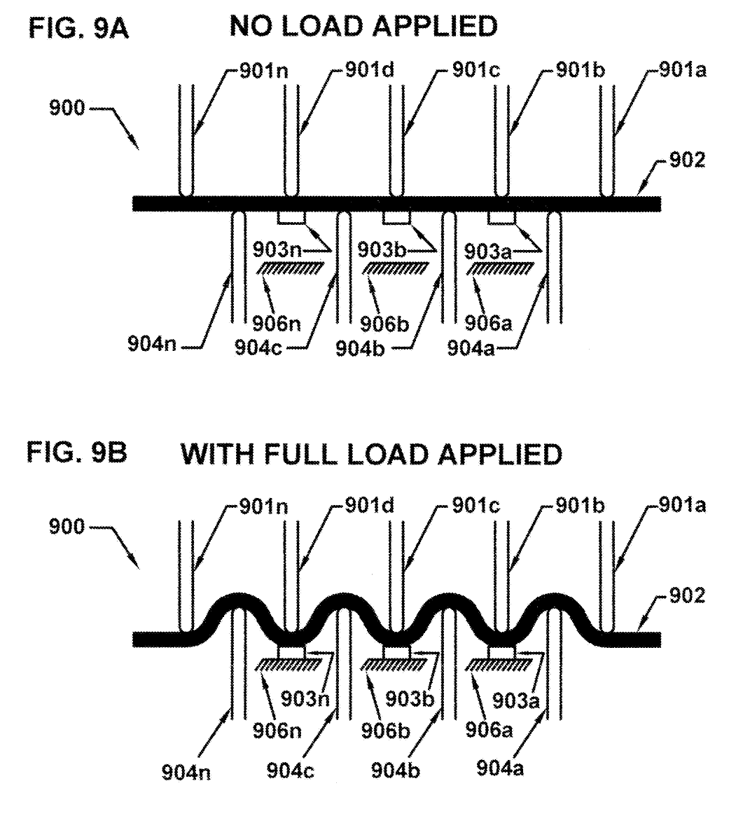

FIGS. 9A-B illustrates an exemplary embodiment 900 of the present invention which utilizes a stroke limiting device 903a-n attached to the elastomeric membrane diaphragm 902. FIG. 9A illustrates the embodiment 900 with the elastomeric membrane diaphragm 902 having no load transmitted by the protrusions 901a-n. FIG. 9B illustrates the embodiment 900 with the load (not shown) applied and the depth of stroke limited by the stroke limiting device 903a-n resting against a surface 906a-n. Protrusions 904a-n support the elastomeric membrane diaphragm 902.

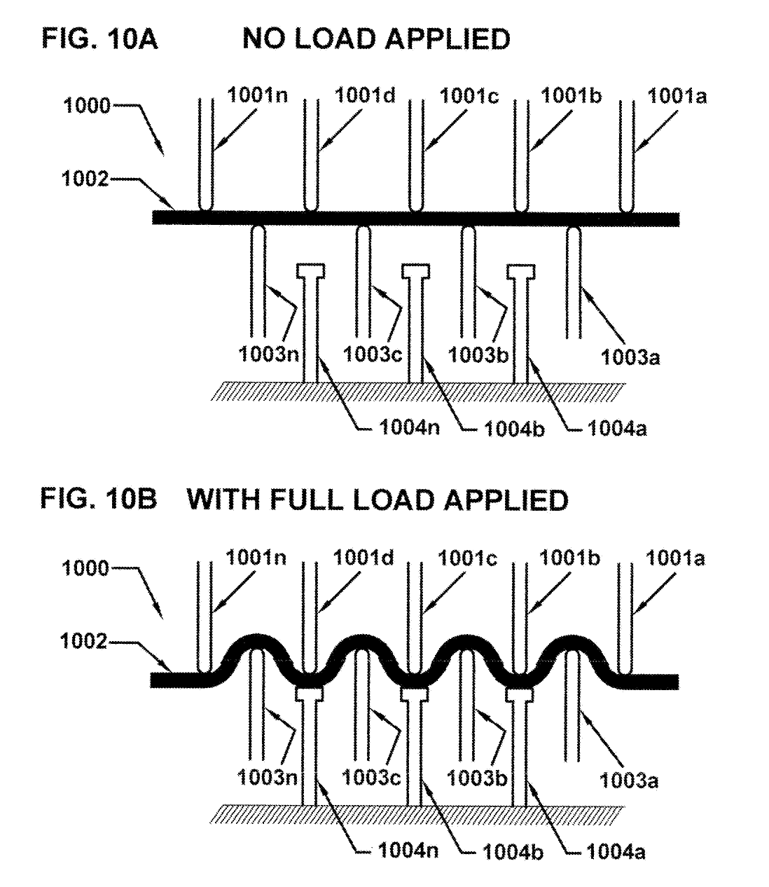

FIGS. 10A-B illustrate an exemplary embodiment 1000 of the present invention which utilizes a stroke limiting device 1004a-n external to the elastomeric membrane diaphragm 1002. FIG. 10A illustrates the embodiment 1000 with the elastomeric membrane diaphragm 1002 having no load. FIG. 10B illustrates the embodiment 1000 with the load (not shown) applied and the depth of stroke limited by the stroke limiting device 1004a-n resting against the diaphragm 1002. Protrusions 1001a-n transmit the load to the diaphragm 1002. Protrusions 1003a-n support the elastomeric membrane diaphragm 1002.

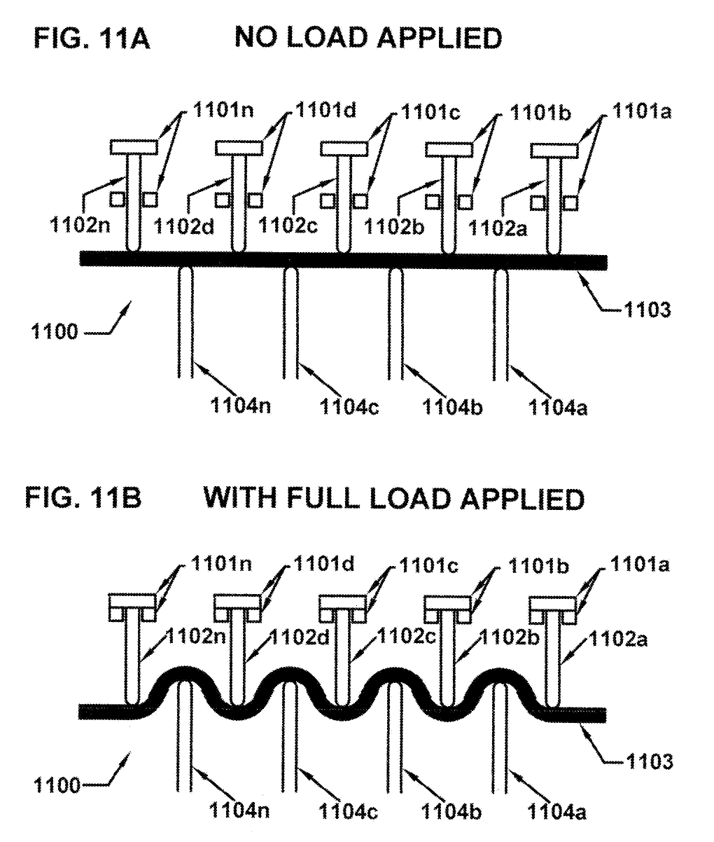

FIGS. 11A-B illustrate an exemplary embodiment 1100 of the present invention which utilizes a stroke limiting device 1101a-n external to the elastomeric membrane diaphragm 1103 with the limiting device 1101a-n attached to the protrusions. FIG. 11A illustrates the embodiment 1100 with the elastomeric membrane diaphragm 1103 having no load. FIG. 11B illustrates the embodiment 1100 with the load (not shown) applied and the depth of stroke limited by the stroke limiting device 1101a-n. Protrusions 1102a-n transmit the load to the diaphragm 1103. Protrusions 1104a-n support the elastomeric membrane diaphragm 1103.

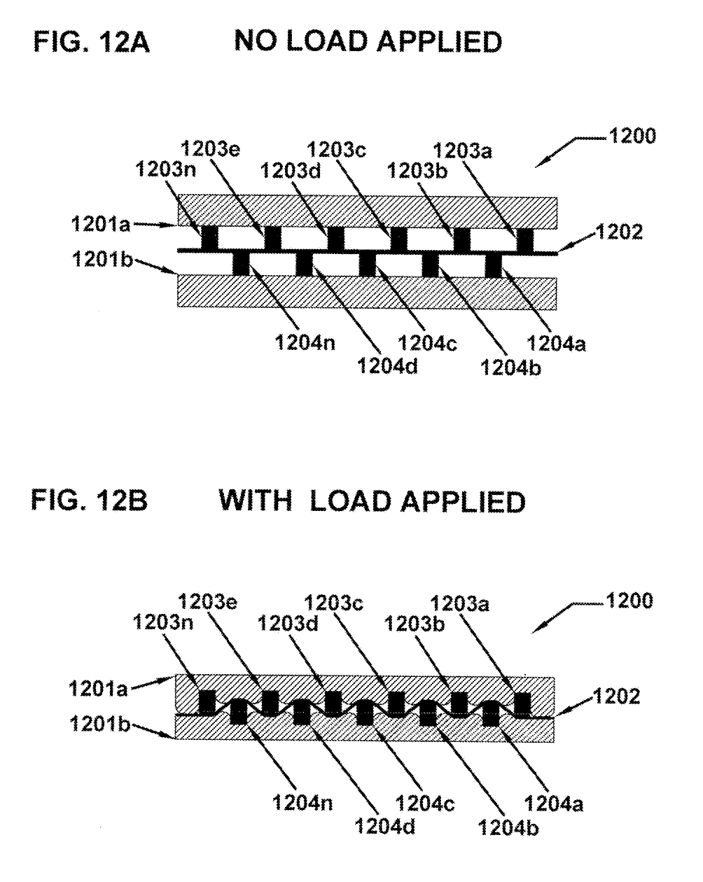

FIGS. 12A-B illustrate an exemplary embodiment 1200 of the present invention which utilizes an elastomeric membrane diaphragm 1202 with integral protrusions 1203a-n, 1204a-n and secondary cushioning materials 1201a, b. FIG. 12A illustrates the embodiment 1200 having no load. FIG. 12B illustrates the embodiment 1100 with the load (not shown) applied. The secondary cushioning materials or elements 1201a, b may or may not be bonded or otherwise affixed or connected to the elastomeric membrane diaphragm 1202 and/or protrusions 1203a-n, 1204a-n. The secondary cushioning elements may be of any appropriate material, preferably resilient. Multiple layers of secondary cushioning elements may be used. Not all of the layers need to be made of the same material. Further, a layer of secondary cushioning material may be used on one side of the embodiment or the other rather than on both sides as shown in FIGS. 12A, B.

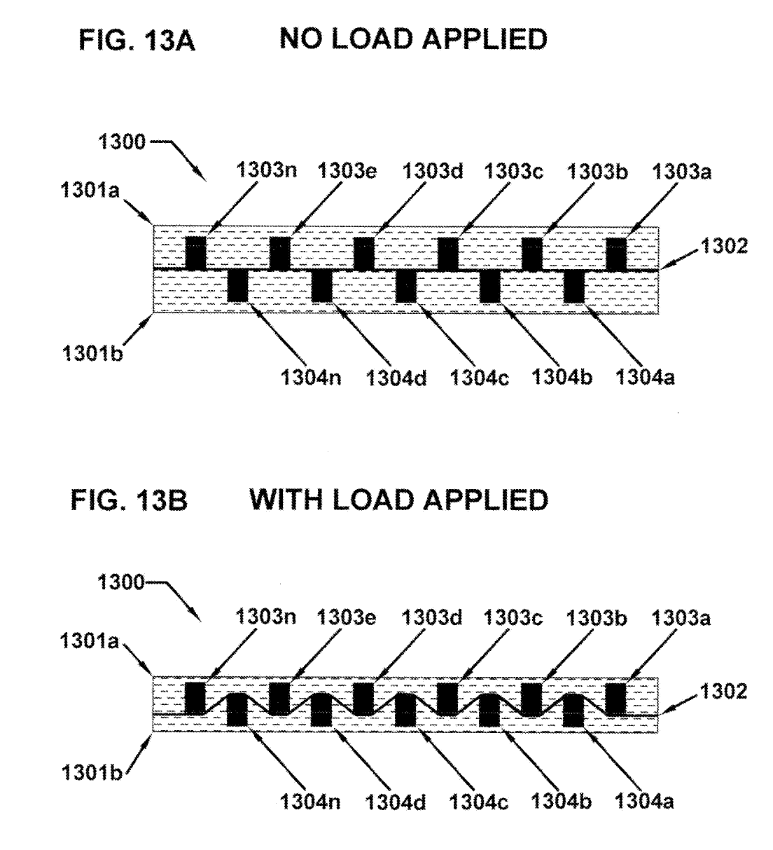

FIGS. 13A-B illustrate an exemplary embodiment 1300 of the present invention which utilizes an elastomeric membrane diaphragm 1302 with integral protrusions 1303a-n, 1304a-n with the addition of secondary cushioning materials 1301a, b bonded to or molded with diaphragm 1302. The secondary cushioning elements 1301a, b may be of any appropriate material, preferably resilient. Multiple layers of secondary cushioning elements may be used. Not all of the layers need to be made of the same material. Further, a layer of secondary cushioning material may be used on one side of the embodiment or the other rather than on both sides as shown in FIGS. 13A, B. FIG. 13A illustrates the embodiment 1300 having no load. FIG. 13B illustrates the embodiment 1100 with the load (not shown) applied.

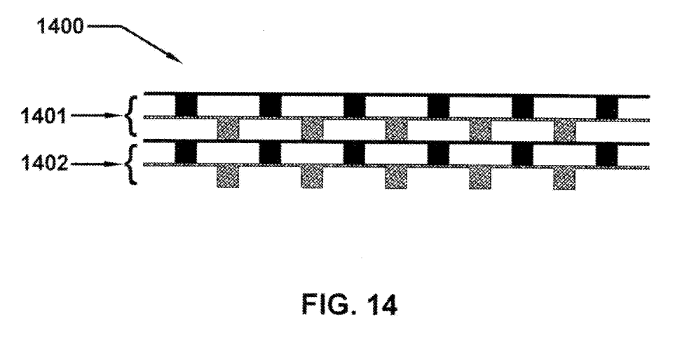

FIG. 14 illustrates an exemplary embodiment 1400 of the present invention which demonstrates that one or more types of the previously described embodiments may be stacked. FIG. 14 shows two stacked cushioning elements 1401, 1402. The stacking may be of all the same type of cushioning elements or may be comprised of varied types. The make up of the stack may be made to fit the desired use. Stacking the cushioning may allow for the lengthening of the cushioning stroke and may provide for an increasing spring rate. Some embodiments of stacked cushioning devices may use an extra membrane as need be between layers or otherwise.

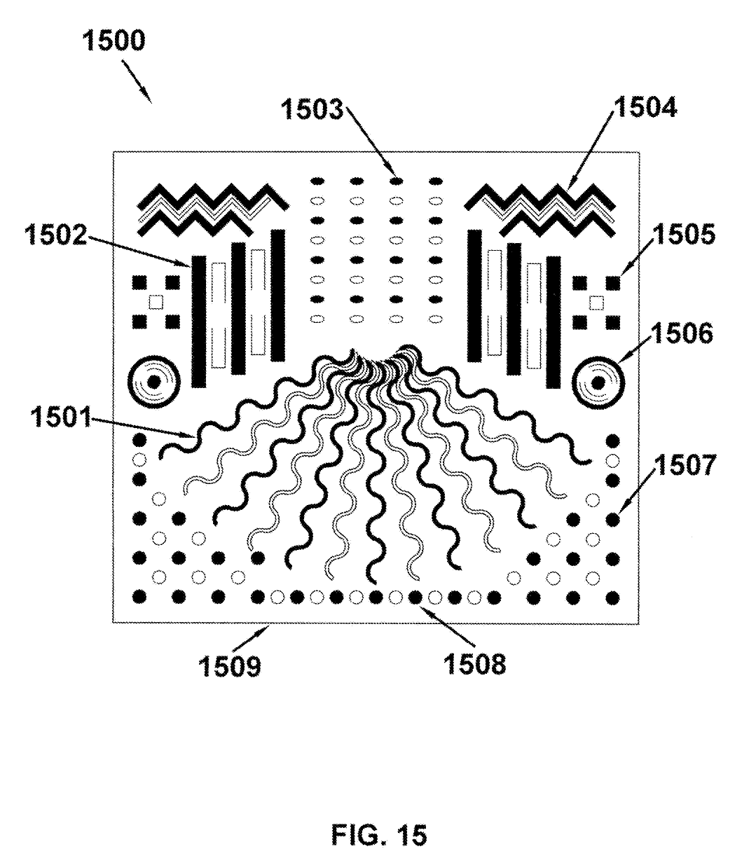

FIG. 15 is a top view of an exemplary cushioning element 1500 with many different types of protrusions used with a membrane 1509. This exemplary embodiment 1500 is provided chiefly to illustrate some of the many types of protrusions that may be used with embodiments of the invention.

In particular, FIG. 15 illustrates a number of possible shapes and orientations for protrusions as may be used with the exemplary embodiments of the invention. These examples may be of varying sizes with respect to each other type and within type. An exemplary cushioning element according to the invention may be made incorporating one or more of the different types of protrusions shown as well as other types or just with other types. This illustration is not intended to be inclusive of all possibilities. Many other shapes and orientations may meet the intent of this invention.

Referring to FIG. 15, bold images indicate protrusions on the visible surface and for purposes of this illustration and may be considered to be the load bearing protrusions. The images with dashed lines indicate the supporting protrusions on the hidden surface. Thus, FIG. 15 may be considered a top view of the exemplary embodiment.

In FIG. 15, as a load is applied, the elastomeric membrane diaphragm 1509 (between the protrusions on the visible surface and the hidden protrusions) distends and the resultant force generated by that distension is the spring or cushioning action previously described. Item 1501 illustrates wavy protrusions. Item 1502 illustrates bar protrusions. Item 1503 illustrates oval protrusions. Item 1504 illustrates chevron protrusions. Item 1505 illustrates square protrusions. Item 1506 illustrates a ring protrusion with a supporting ring protrusion. Item 1507 illustrates round protrusions with the supporting protrusions oriented in the space defined by multiple load bearing protrusions. Item 1508 illustrates round protrusions with the supporting protrusions oriented in-line with the load bearing protrusions.

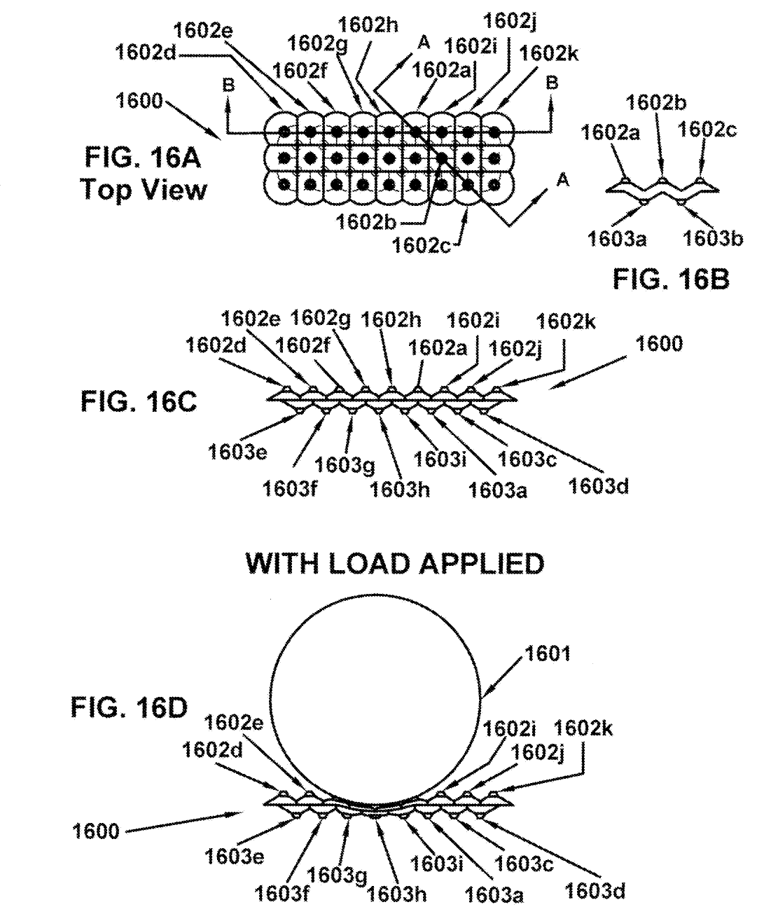

FIGS. 16A-D illustrate an exemplary embodiment 1600 of the present invention. FIG. 16A is a top view of the embodiment 1600. FIG. 16B is a cut away side view of the embodiment taken along the diagonal line A-A shown in FIG. 16A. FIG. 16C is a cut away view taken along the line B-B shown in FIG. 16A. FIG. 16D is a partial side view of the embodiment 1600 with a load 1601 applied.

FIG. 16A shows this embodiment 1600 to include three rows of nine protrusions on a first side (visible side in FIG. 16A or “top” side) of the embodiment. The embodiment 16 includes two rows of eight protrusions on the other side (hidden side in FIG. 16A or “bottom” side) of the embodiment. The protrusions on the respective sides of the embodiment 1600 are stagger positioned, which may also be referred to as offset placement. In particular, the two rows of eight protrusions on the hidden side are positioned between the three rows of nine protrusions on the visible side of the embodiment. The cutaway view in FIG. 16B shows three of the protrusions 1602a-c on the top side of the embodiment and two of the protrusions 1603a-b on the bottom side of the embodiment. FIG. 16B particularly shows the offset placement of the top protrusions 1602a-c and the bottom protrusions 1603b.

FIG. 16C also illustrates the offset placement of the top protrusions versus the bottom protrusions. As noted, FIG. 16C is a cut away view taken along the line B-B in FIG. 16A. Thus, FIG. 16C shows the top protrusions 16a, 16d-k which are the protrusions in the upper most row of top protrusions shown in FIG. 16A. FIG. 16C also shows the bottom protrusions 1603a, 1603c-i which are the protrusions in the upper most row of bottom protrusions shown in FIG. 16A.

Also as shown in FIGS. 16A-D, the protrusions are all shaped as truncated cones but of different sizes between the top protrusions and the bottom protrusions. To generate an increasing rate of cushioning as load is applied, a smaller truncated cone protrusion with a lesser internal angle is combined with a larger truncated cone protrusion of a larger internal angle. The larger cone is used for the top protrusions and the smaller cone is used for the bottom protrusions. But the terms “top” and “bottom” as noted previously are useful in interpreting the two dimensional figures but should not be used in limiting the features of the exemplary embodiment. The embodiment 1600 may be used with either the larger protrusions or the smaller protrusions on “top”.

Continuing with references to FIGS. 16A-D, in this exemplary embodiment 1600, the bases of the larger protrusions overlap to become an elastomeric membrane diaphragm of varying thickness.

In this embodiment 1600, the resultant load bearing force is generated by the combined forces of elastomeric membrane diaphragm tensioning, the resistant forces to bending movement, and the resistant forces to column or strut compression. The smaller protrusion generates the initial resistance to the applied load. As the smaller protrusion compresses, the larger protrusion begins to generate a larger resistance to the load. In this embodiment 1600, the protrusions and the elastomeric membrane diaphragm may be constructed of similar materials. The larger protrusions may display characteristics consistent with a load transmitting protrusion and may display characteristics consistent with the elastomeric membrane diaphragm. The larger protrusion may both transmit the load to the elastomeric membrane diaphragm as well as distend as part of the elastomeric membrane diaphragm and generate resultant tensioning and moment forces.

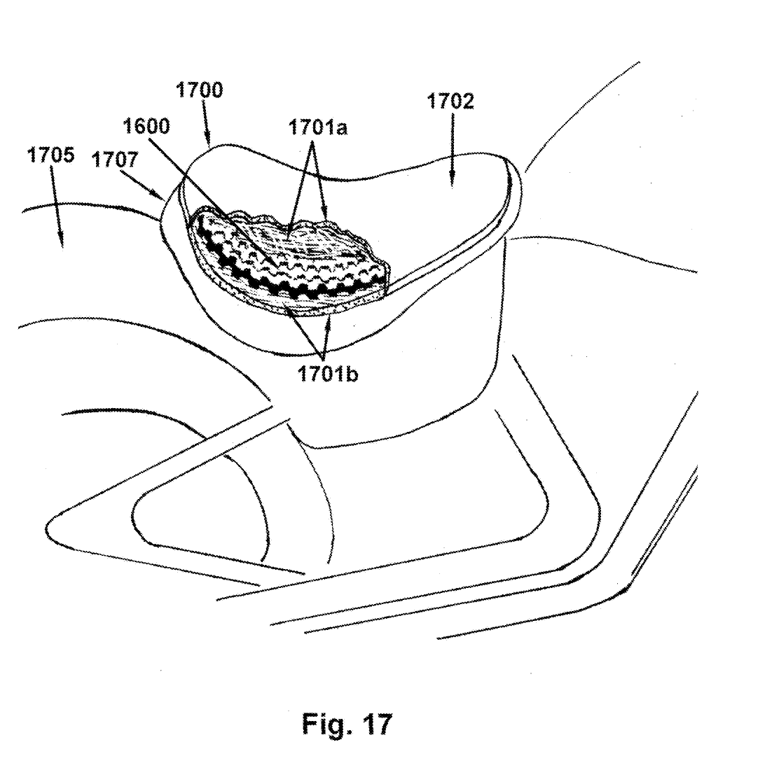

FIG. 17 illustrates the exemplary embodiment 1600 of FIG. 16 as it may be used for example as part of an assembly 1700 to function at least in part as a cushion or part of a cushion used on a motorcycle 1705 (shown in part) for motorcycle operator and/or passenger comfort. In this assembly 1700, multiple secondary cushioning elements 1701a, b are employed (see description related to FIG. 12). The assembly 1700 of the cushioning element 1600 and the multiple secondary cushioning elements 1701a, b may be contained in a weather resistant protective cover 1702. The cover 1702 is cut away in part to view the parts of the assembly 1700 including a top and sectioned edge view of the cushioning element 1600 of FIG. 16 and the cushioning elements 1701a, b in part. In this use of the embodiment 1700, the cushioning element 1600 may act as a cushioning interface. The assembly 1700 may conform to the surface of the motorcycle seat 1707 and also may conform to the contour of the rider, thereby reducing the intensity of pressure points experienced by the rider.

Implementation of the invention into exemplary embodiments may include additional considerations depending on the desired use of a particular embodiment or for other reasons. For example, the elastomeric membrane diaphragm in a particular embodiment may contain openings or holes. They may aid in the control of reaction.

Another consideration relates to the previously discussed point that exemplary cushioning devices according to the invention may be stacked. Stacked devices may allow for a longer stroke. A longer stroke may allow for more travel distance as the load is applied. Stacked devices may be of differing durometer and/or design (respectively). Such differences among layers may allow for controlling the deceleration and amount of cushioning as the load is increasingly applied.

Further, consideration may be given to the use of protrusions of a yieldable material. Such yieldable material may result in additional cushioning and compressive stroke.

Additional considerations include: protrusion shape, dimensions, and cross section design may be varied within a cushioning device or stack of devices. Protrusions may be of any geometric cross section, artistic design, bar, wavy, hatch, herring bone, dimension or other configuration. Protrusions may be connected or free standing (or the combination) with a cushioning device or a stack of devices. Protrusion spacing, arrangement, array, and design may vary depending on stroke required, cushioning needs, load reaction, and spring rate requirements. Other attachments (other than the protrusions) may be affixed (or otherwise connected) to the membrane of an exemplary cushioning device. These may be added to aid in controlling reaction. They may be “attached protrusions”. Stroke limiting devices may be engineered into a cushion device as may be desired or required for particular result.

The following points may have specific regard to the membrane, but also may apply to the protrusions and/or the cushioning device as a whole. For example, uniformity in thinness or thickness may vary. The variance may be across a particular membrane, protrusion or device in a particular direction, radially, or otherwise. The variance may be across a stack of cushioning devices. The composition of a elements of a cushioning device may vary. The size and/or shape of the elements of a cushioning device may vary. The tautness of the membrane and/or protrusion with no load may vary among embodiments or within a particular embodiment. The membrane, protrusions and/or cushioning device may be used with protective element(s) to prevent or limit damage. Combinations of molded protrusions may be used with protrusions that are externally supported with respect to the membrane.

Yet other considerations include the point that mechanisms that support a cushioning element may vary. The level of support from a support mechanism may vary. Peripheral support of a cushioning element (or stack of such elements) may be hinged, rigid, unrestrained, and/or other or a combination thereof.

Other considerations relate to the loads that may be applied to the exemplary cushioning devices. That may be multi-axial, such as vibration and impact dampening. In applications where the load is multi-axial, the resulting tension in the elastomeric membrane may or may not be uniform.

### CONCLUSION

The exemplary embodiments of the invention were chosen and described above in order to explain the principles of the invention and its practical applications so as to enable others skilled in the art to utilize the inventions including various embodiments and various modifications as are suited to the particular uses contemplated. The examples provided herein are not intended as limitations of the present invention. Other embodiments will suggest themselves to those skilled in the art. Therefore, the scope of the present invention is to be limited only by the claims below.

We claim:

1. A cushioning element, comprising:
a membrane having two sides;
units extending from each of the two sides of the membrane; and
the units on one side being stagger positioned with respect to the units on the other side so that depression of a unit on the one side of the membrane causes displacement of at least part of the other side of the membrane generally opposite to the unit being depressed.

2. The cushioning element of claim 1, wherein the membrane comprises a consistent resiliency throughout.

3. The cushioning element of claim 1, wherein at least a part of the membrane comprises a resiliency different from other parts of the membrane.

4. The cushioning element of claim 1, wherein release of the depression of the unit allows that part of the membrane that was displaced to return to at least substantially its position prior to the depression.

5. The cushioning element of claim 1, wherein initial depression of the unit causes at least some compression of it.

6. The cushioning element of claim 5, wherein release of the initial depression of the unit causes at least its substantial decompression.

7. The cushioning element of claim 1, wherein additional depression of the unit moves at least part of the unit into a space on the other side of the membrane.

8. The cushioning element of claim 7, wherein release of the additional depression of the unit causes the moved part of it to return substantially at least to its position prior to the additional depression.

9. The cushioning element of claim 1, wherein at least a unit on the one side of the membrane comprises a resiliency different from other units on the one side of the membrane.

10. The cushioning element of claim 1, wherein at least a unit on the one side of the membrane is shaped differently from other units on the one side of the membrane.

11. The cushioning element of claim 1, wherein at least a unit on the one side of the membrane is sized differently from other units on the one side of the membrane.

12. The cushioning element of claim 1, wherein at least a unit on the one side of the membrane is attached to the membrane differently from other units on the one side of the membrane.

13. The cushioning element of claim 1, wherein at least some of the units on one side of the membrane are disposed in generally parallel rows and generally parallel columns with the rows and the columns being generally perpendicular to each other.

14. The cushioning element of claim 1, wherein the units on one side of the membrane are sized differently from the units on the other side of the membrane.

15. The cushioning element of claim 1, wherein the units on one side of the membrane are shaped differently from units on the other side of the membrane.

16. The cushioning element of claim 1, wherein the membrane, the top protrusions, and the bottom protrusions are integrally made.

17. The cushioning element of claim 1, wherein at least one of the units is shaped as an inverted cone.

18. An apparatus positionable between a vibration source and a pressure source, comprising:
pressure source-side members with each member oriented towards the pressure source;
vibration-side elements with each element oriented towards the vibration source, at least two of the elements positioned so as to define an area between them; and
at least one of the members being positioned generally opposite to the area between the two elements, the member being at least partially compressible in response to pressure from the pressure source; and
the vibration-side elements being at least partially absorptive of vibration from the vibration source.

19. A device usable for cushioning or shock absorption, or both, comprising:
upward projections on the device;
downward projections on the device;
the downward projections being staggered in positional relation to the upward projections; and
at least one of the upward projections being compressible in response to pressure and also being resilient in response to removal of the pressure.

20. The device of claim 19, wherein at least part of a downward projection is capable of being distorted into a position between at least two of the upward projections; and
wherein at least part of an upward projection is capable of being distorted into a position between at least two of the downward projections.
